(19) United States
(12) Patent Application Publication
(10) Pub. No.: US 2026/0093208 A1
(43) Pub. Date: Apr. 2, 2026

(54) APPARATUS FOR MANUFACTURING HOLOGRAM OPTICAL ELEMENT, AND METHOD FOR MANUFACTURING HOLOGRAM OPTICAL ELEMENT

(71) Applicant: Panasonic Intellectual Property Management Co., Ltd., Osaka (JP)

(72) Inventors: ATSUSHI FUKUI, Osaka (JP); KENICHIRO MASE, Osaka (JP); WAHEI AGEMIZU, Osaka (JP)

(21) Appl. No.: 19/411,745

(22) Filed: Dec. 8, 2025

Related U.S. Application Data
(63) Continuation of application No. PCT/JP2024/020586, filed on Jun. 5, 2024.

(30) Foreign Application Priority Data
Jun. 21, 2023 (JP) 2023-101701

(51) Int. Cl. G03H 1/04; G02B 5/32

(52) U.S. Cl. CPC G03H 1/041; G03H 1/0408; G02B 5/32; G03H 2001/0439; G03H 2223/16; G03H 2223/22; G03H 2223/24

(57) ABSTRACT

An apparatus for manufacturing a hologram optical element includes laser light source (1), branching mirror (4) that branches laser light (L1) emitted from laser light source (1) into laser light (L2) and laser light (L2), mirror (6) that reflects laser light (L2), light guide plate (20) including hologram optical element (11a), coupler (10a) that causes laser light (L3) to enter light guide plate (20), and a mover that moves a radiation position of laser light (L3).

### TECHNICAL FIELD

The present disclosure relates to an apparatus for manufacturing a hologram optical element and a method for manufacturing a hologram optical element.

### BACKGROUND ART

Conventionally, manufacturing apparatuses for manufacturing a hologram optical element are known. For example, in PTL 1, a light beam emitted from a laser light source is split into S-polarized light and P-polarized light by a polarizing beam splitter, and a recording medium is irradiated with these light beams to create a volume hologram (hologram optical element).

### CITATION LIST

### Patent Literature

PTL 1: Unexamined Japanese Patent Publication No. 2021-12249

### SUMMARY OF THE INVENTION

Incidentally, in conventional hologram manufacturing apparatuses, when exposing a hologram light guide plate, it is necessary to irradiate the hologram light guide plate with exposure light in such a way as to achieve an angle of light propagating in the hologram light guide plate. Generally, a coupler is used to adjust the angle of exposure light with respect to the hologram light guide plate. Usually, the coupler is disposed in such a way as to cover entirety of one surface of the hologram light guide plate at a time of exposure of the hologram light guide plate. Therefore, when the hologram light guide plate increases in size, the coupler also increases in size. Usually, since size and weight of the coupler are proportional to a cube of length, it is necessary to hold a very heavy and large coupler in order to produce a large hologram light guide plate. In addition, in order to accurately irradiate the hologram light guide plate with the exposure light, it is necessary to fill a gap between the coupler and the hologram light guide plate with matching oil without air bubbles, and when the coupler becomes large, setting before the exposure becomes very difficult. Furthermore, in order to produce a large coupler, a large glass block without distortion or cracking is required, and difficulty of production increases.

Therefore, an object of the present disclosure is to provide a method for manufacturing a hologram optical element capable of suppressing size of a coupler.

In order to achieve the above object, an apparatus for manufacturing a hologram optical element according to an exemplary embodiment of the present disclosure includes a laser light source, a half mirror that branches light radiated from the laser light source into first light and second light, a mirror that reflects the first light, the mirror being created based on a shape of a product in which a hologram optical element is used, a light guide plate including the hologram optical element, a coupler that causes the second light to enter the light guide plate and propagate in the light guide plate while undergoing total reflection, and a mover that moves a radiation position of the second light with respect to the coupler.

According to the present disclosure, size of a coupler can be suppressed.

### BRIEF DESCRIPTION OF THE DRAWINGS

FIG. 1 shows a side view of an apparatus for manufacturing a hologram optical element according to an exemplary embodiment.

FIG. 2 shows a top view of the apparatus for manufacturing a hologram optical element according to the exemplary embodiment.

FIG. 3 shows graphs each illustrating a light intensity distribution in the apparatus for manufacturing a hologram optical element according to the exemplary embodiment.

FIG. 4 shows a diagram for explaining light intensity distribution control in the apparatus for manufacturing a hologram optical element according to the exemplary embodiment.

FIG. 5 shows cross-sectional views of a light guide plate using a volume hologram manufactured by the apparatus for manufacturing a hologram optical element according to the exemplary embodiment.

FIG. 6 shows cross-sectional views each illustrating a state of light propagation in volume hologram according to the exemplary embodiment and a comparative example.

FIG. 7 shows a side view of an apparatus for manufacturing a hologram optical element according to a reference example.

### DESCRIPTION OF EMBODIMENT

An exemplary embodiment of the present disclosure will be described in detail hereinafter with reference to the drawings. The following description of the preferred exemplary embodiment is merely essentially an example, and is not intended to limit the present invention and applications or uses of the present invention. Note that, in the following description, the same parts are denoted by the same reference numerals, and detailed description thereof is omitted as appropriate.

Note that a volume hologram used in the present disclosure is different from a two-dimensional diffraction grating having a surface with fine periodic irregularities, and records a refractive index distribution in a volume in three dimensions in a sinusoidal shape. By controlling a direction and a period of this sine wave and amplitude of a refractive index difference, light distribution of the volume hologram can be controlled.

### Exemplary Embodiment

### (Overall Configuration of Apparatus for Manufacturing Hologram Optical Element)

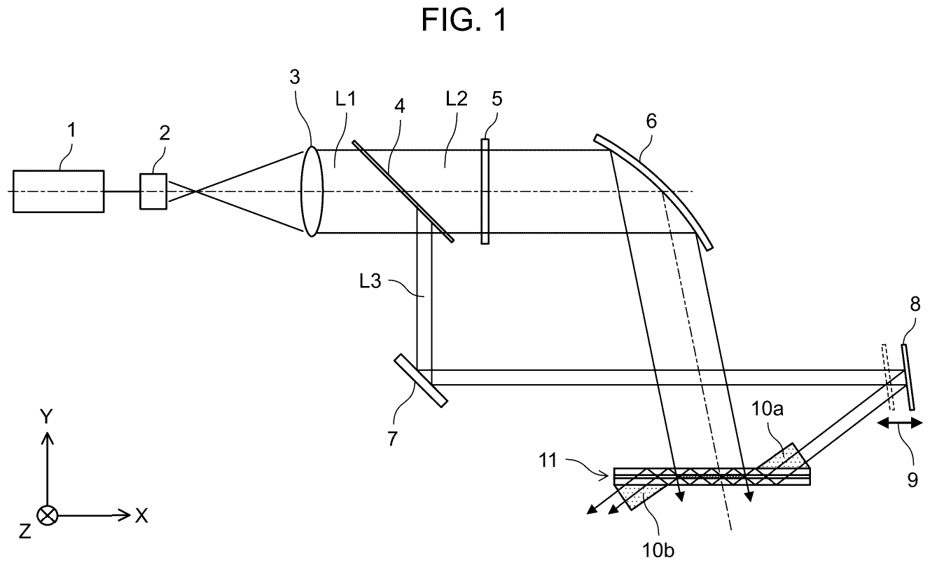

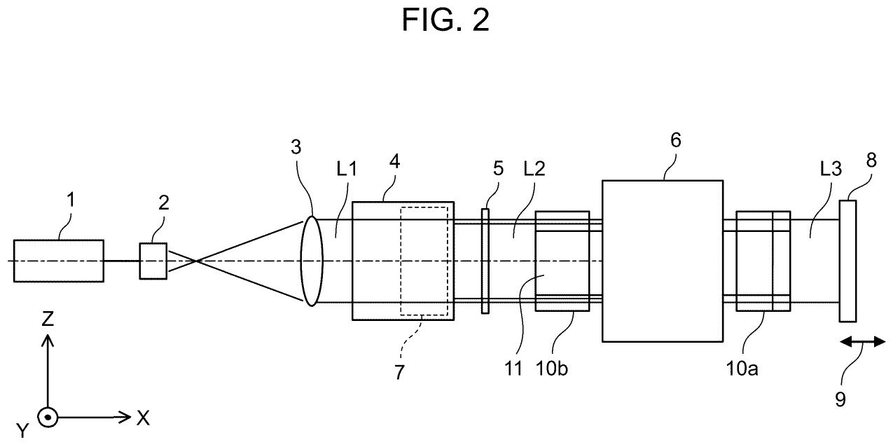

FIG. 1 is a side view of an apparatus for manufacturing a hologram optical element according to the present exemplary embodiment. FIG. 2 is a top view of the apparatus for manufacturing a hologram optical element according to the present exemplary embodiment. Note that, in FIG. 1, a radiation direction of a laser beam is an X direction, a thickness direction (vertical direction) of the volume hologram is a Y direction, and a direction perpendicular to the X direction and the Y direction is a Z direction.

As illustrated in FIG. 1, the device for manufacturing a hologram optical element according to the present exemplary embodiment includes laser light source 1, condenser lens 2, collimator lens 3, branching mirror 4 (half mirror), filter 5, mirrors 6 to 8, slider 9 (mover), couplers 10a, 10b, and volume hologram 11 (a light guide plate and a hologram optical element).

Laser light source 1 is a light source that irradiates condenser lens 2 with laser light L1. Laser light source 1 is a laser light source having high coherence. Therefore, even if laser light L2, L3 is separated from the same optical path length after laser light L1 is branched into laser light L2 (object light) and laser light L3 (reference light) by branching mirror 4 described below, it is possible to generate interference of light with each other. Furthermore, laser light L1 has characteristics of linear polarization, and when a polarization ratio is insufficient, a wave plate, a polarizing plate, or the like may be inserted to control a polarization direction.

Condenser lens 2 is a lens that condenses laser light L1 from laser light source 1. Laser light L1 condensed by condenser lens 2 becomes enlarged light after being condensed (see FIG. 1). Laser light L1 has a distribution generally called a Gaussian distribution in which light intensity is high at a center and decreases toward a periphery. Since it is desirable that in-plane intensity distribution of light necessary for the interference is substantially constant, the enlarged light in a central portion is used, and the other light is shielded and not used. In FIG. 1, unnecessary light is omitted, and only a light flux to be used is illustrated.

Collimator lens 3 is a lens that converts laser light L1 diffused by condenser lens 2 into collimated light. Specifically, collimator lens 3 is disposed such that focal length f thereof coincides with a distance to a focal point of laser light L1 condensed by condenser lens 2.

Branching mirror 4 branches laser light L1 converted into collimated light by collimator lens 3 into two light fluxes (laser light L2 (object light) and laser light L3 (reference light)).

Filter 5 is an element that controls transmittance concentration for transmitted laser light L2. Filter 5 can be achieved by means such as changing thickness of chromium plating.

Mirror 6 is a mirror that reflects laser light L2 transmitted through filter 5. Specifically, mirror 6 is formed based on a shape of a product in which volume hologram 11 is used. For example, when volume hologram 11 is used as a light guide plate for projecting an image on a windshield of a vehicle or the like, mirror 6 is formed in a shape of the windshield of the vehicle. Volume hologram 11 is irradiated with reflected light (laser light L2) from mirror 6. Distribution of the transmittance concentration of filter 5 is set such that intensity distribution of laser light L2 radiated onto volume hologram 11 becomes intensity of light emitted from volume hologram 11 when light is incident on volume hologram 11 for reproduction.

Mirror 7 is a mirror that reflects laser light L3 incident from branching mirror 4 to mirror 8.

Mirror 8 is a mirror that reflects laser light L3 incident from mirror 7 to volume hologram 11. Mirror 8 is provided with slider 9 for moving mirror 8. In the present exemplary embodiment, slider 9 moves mirror 8 in the X direction.

Coupler 10a is disposed on a surface of volume hologram 11 on mirror 8 side. Coupler 10a has a prism surface shaped in accordance with an incident angle of laser light L3 (reference light).

Coupler 10b is disposed on a surface of volume hologram 11 opposite mirror 8. Coupler 10b has a prism surface shaped in accordance with an incident angle of laser light L3 (reference light). Coupler 10b serves to extract laser light L3 propagated in volume hologram 11 while undergoing total reflection, and prevents laser light L3 from being confined in volume hologram 11.

As described above, when laser light L2, L3 incident on volume hologram 11 overlaps each other in volume hologram 11, interference fringes are generated in volume hologram 11. The interference fringes are bright and dark sinusoidal fringes, and volume hologram 11 as a photosensitive material is photosensitive in bright portions and not photosensitive in dark portions. In the photosensitive portions, refractive index changes corresponding to the amount of energy of light occur. Therefore, a refractive index distribution is generated in a sinusoidal shape based on the interference fringes generated in a sinusoidal shape. The hologram optical element can be formed by stopping light radiation when a necessary difference in refractive index is caused and then irradiating volume hologram 11 with light having a specific wavelength, such as ultraviolet rays, to fix the refractive index distribution.

In the hologram optical element (volume hologram 11), since the refractive index difference based on the interference fringes of the interference between the two light fluxes of laser light L2, L3 is recorded, a diffraction phenomenon based on the two light fluxes occurs. When light is incident in the same direction and at the same angle as laser light L3 (reference light), diffracted light in the same direction and at the same angle as laser light L2 (object light) is generated. When light is input in the same direction and at the same angle as laser light L2 (object light), laser light L3 (reference light) is generated. On the other hand, when laser light L3 (reference light) is input from an opposite direction, laser light L2 (object light) generates light diffracted toward mirror 6. Therefore, when this light is reflected by mirror 6, subsequent light becomes collimated light. A virtual image optical system can be constructed using the collimated light, and reflected collimated light can be easily obtained using the hologram light guide plate even with a complicated design shape.

### (Luminance Distribution of Volume Hologram)

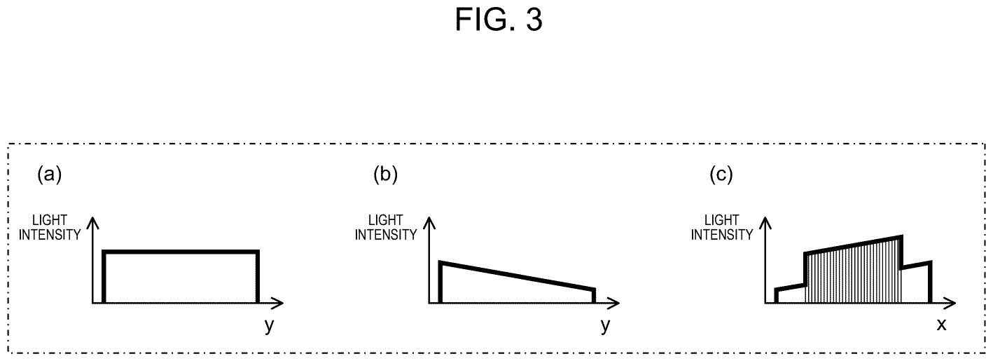

FIG. 3 is a graph illustrating a light intensity distribution in the apparatus for manufacturing a hologram optical element according to the exemplary embodiment. Specifically, FIG. 3(a) is a graph illustrating a light intensity distribution of laser light L3 after transmission through branching mirror 4, FIG. 3(b) is a graph illustrating a light intensity distribution of laser light L2 after transmission through filter 5, and FIG. 3(c) is a graph illustrating a light intensity distribution of the laser light radiated onto volume hologram 11. Note that, in FIG. 3(c), laser light L2, L3 overlaps in a central region.

As illustrated in FIG. 1, laser light L2, L3 overlaps each other in volume hologram 11. As a result, interference fringes are recorded (formed) in volume hologram 11.

Here, as described above, the distribution of the transmittance concentration of filter 5 is set such that the intensity distribution of laser light L2 radiated onto volume hologram 11 becomes intensity of light emitted from volume hologram 11 when light is incident on volume hologram 11 for reproduction. As a result, the interference fringes formed in volume hologram 11 have a configuration in which diffraction efficiency gradually increases from a left side in the drawing of FIG. 1 to a right side in the drawing. Therefore, as illustrated in FIG. 3(c), a diffraction grating is recorded in volume hologram 11 in a part of the central region where laser light L2, L3 overlaps.

As a method of setting the distribution of the transmittance concentration of filter 5, any method may be used as long as the light intensity distribution (intensity distribution) of laser light L2 transmitted through filter 5 is achieved. For example, filter 5 may include ¼ wave plate 51, phase modulation element 52, and polarizing plate 53.

Specifically, branching mirror 4 includes a polarization prism splitter or the like, and transmits linearly polarized light (laser light L2) in a first polarization direction and reflects linearly polarized light (laser light L3) in a second polarization direction among in laser light L1. Laser light L2 transmitted through branching mirror 4 is then converted into circularly polarized light by ¼ wave plate 51. Thereafter, a wavelength of laser light L2 is modulated by the phase modulation element. At this time, laser light L2 is modulated to a different wavelength depending on an incident region of phase modulation element 52.

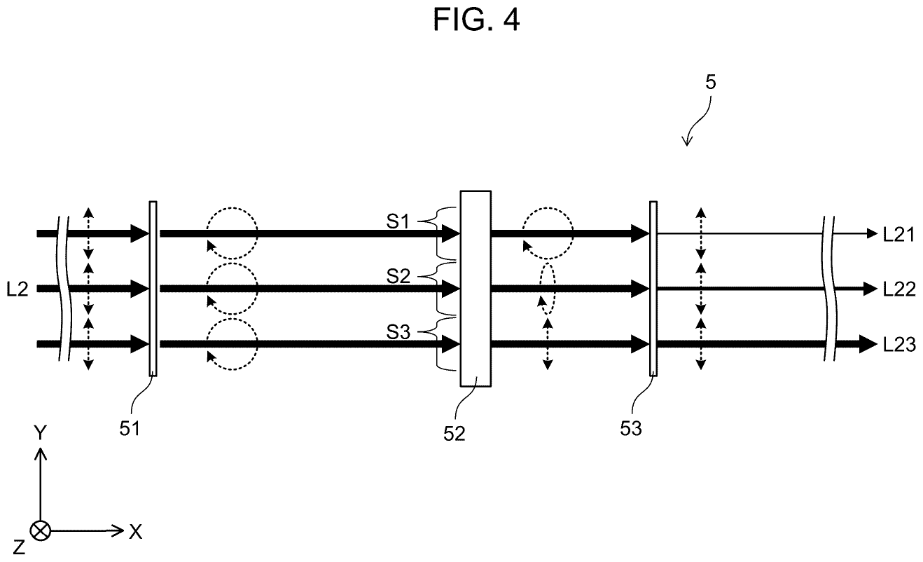

FIG. 4 is a diagram for explaining light intensity distribution control in the apparatus for manufacturing a hologram optical element according to the present exemplary embodiment. In FIG. 4, an amount of phase modulation of phase modulation element 52 gradually increases from region S1 in an upper part of the drawing to region S3 in a lower part of the drawing. For example, since region S1 of phase modulation element 52 in an upper-left part of the drawing does not modulate a wavelength of incident light, incident laser light L2 (L21) is reflected as circularly polarized light. In addition, since region S2 of phase modulation element 52 at a center of the drawing modulates a wavelength of incident light by ⅝ wavelength, incident laser light L2 (L22) is converted into elliptically polarized light. In addition, since region S3 of phase modulation element 52 at the center of the drawing modulates a wavelength of incident light by ½ wavelength, incident laser light L2 (L23) is converted into linearly polarized light.

Thereafter, laser light L3 passes through polarizing plate 53. Polarizing plate 53 transmits light in the second polarization direction. Therefore, in laser light L2 (L23) reflected by a region (for example, region S3) of phase modulation element 52 where the amount of phase modulation is large, a decrease in light intensity due to polarizing plate 53 is small, and in laser light L2 (L21) reflected by a region (for example, region S1) of phase modulation element 52 where the amount of phase modulation is small, a decrease in light intensity due to polarizing plate 53 is large. For example, light intensity of laser light L21 is about 50% of light intensity of laser light L2, and light intensity of laser light L23 is about 66% of the light intensity of laser light L2.

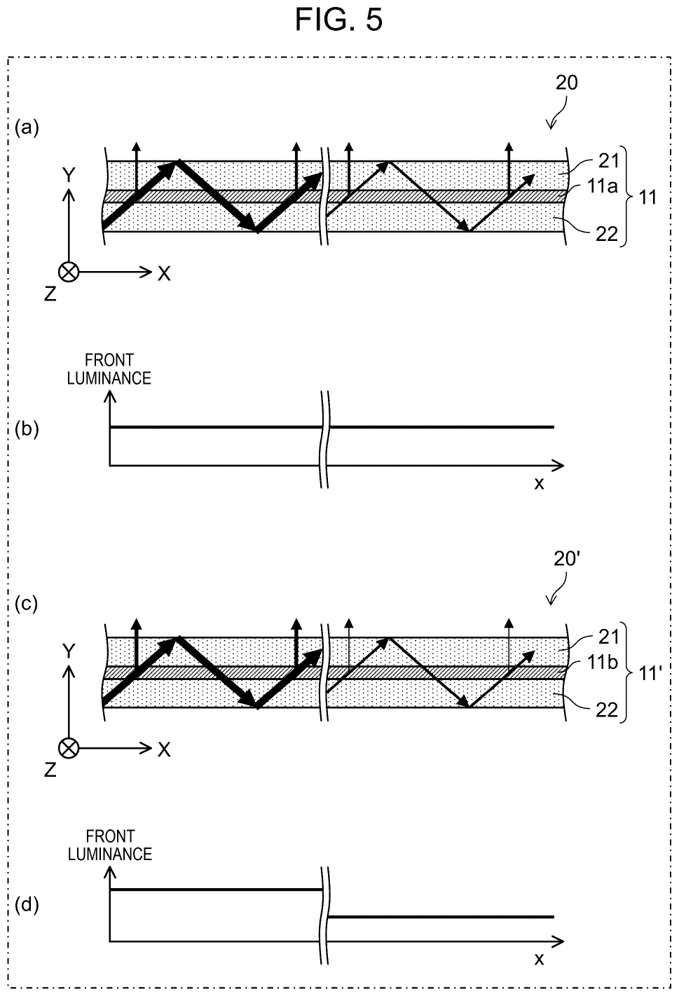

FIG. 5 is a cross-sectional view of a light guide plate using a volume hologram manufactured by the apparatus for manufacturing a hologram optical element according to the present exemplary embodiment. Specifically, FIG. 5(a) is a cross-sectional view of a light guide plate using volume hologram 11 according to the present exemplary embodiment, FIG. 5(b) is a graph illustrating front luminance in FIG. 5(a), FIG. 5(c) is a cross-sectional view of light guide plate 20′ using volume hologram 11′ in which diffraction efficiency of interference fringes is constant, and FIG. 5(d) is a graph illustrating front luminance in FIG. 5(c).

As illustrated in FIG. 5(a), light guide plate 20 according to the present exemplary embodiment includes volume hologram 11. In volume hologram 11, hologram optical element 11a is disposed between transparent substrates 21, 22. Transparent substrates 21, 22 may be flat or curved, and sizes thereof vary from several mm square order to several 100 mm square order depending on an application. Light guide plate 20 is generally used for an application in which light is extracted from a surface in a method of disposing concave or convex prism patterns on front and back surfaces of a transparent substrate or a method of mixing a diffusion material, but a hologram light guide plate using a hologram optical element has a high effect of extracting light in a specific direction, and has preferable characteristics for an application in which light distribution control is required.

On the other hand, as illustrated in FIG. 5(c), light guide plate 20′ includes volume hologram 11′. In volume hologram 11′, hologram optical element 11b is disposed between transparent substrates 21, 22. Volume hologram 11′ (hologram optical element 11b) is formed such that diffraction efficiency of interference fringes is constant.

Although not illustrated in the parts (a) and (c) of FIG. 5, a light source is disposed on an upper side (transparent substrate 21 side) of light guide plate 20 (20′) in the drawing, and light emitted from the light source undergoes total reflection in transparent substrates 21, 22 and propagates to a right side in the drawing. Light is then radiated to the upper side of the drawing in accordance with the interference fringes recorded in hologram optical element 11a (11b) disposed in light guide plate 20 (20′). Note that, even if a light source is disposed on a lower side (transparent substrate 22 side) of light guide plate 20 (20′) in the drawing, light is radiated to the upper side in the drawing.

Here, the amount of light propagating through light guide plate 20 (20′) decreases (attenuates) as the light goes away from the light source. Therefore, when light guide plate 20′ using volume hologram 11′ (hologram optical element 11b) in which diffraction efficiency of interference fringes is constant is used, a luminance distribution in which light intensity gradually decreases from a left side of the drawing to a right side of the drawing is obtained, and front luminance of the light guide plate cannot be constant (see FIG. 5(d)). On the other hand, since volume hologram 11 (hologram optical element 11a) according to the present exemplary embodiment has a configuration in which diffraction efficiency gradually increases from the left side of the drawing to the right side of the drawing (see FIG. 3(c)), front luminance of light guide plate 20 can be kept constant (see FIG. 5(b)).

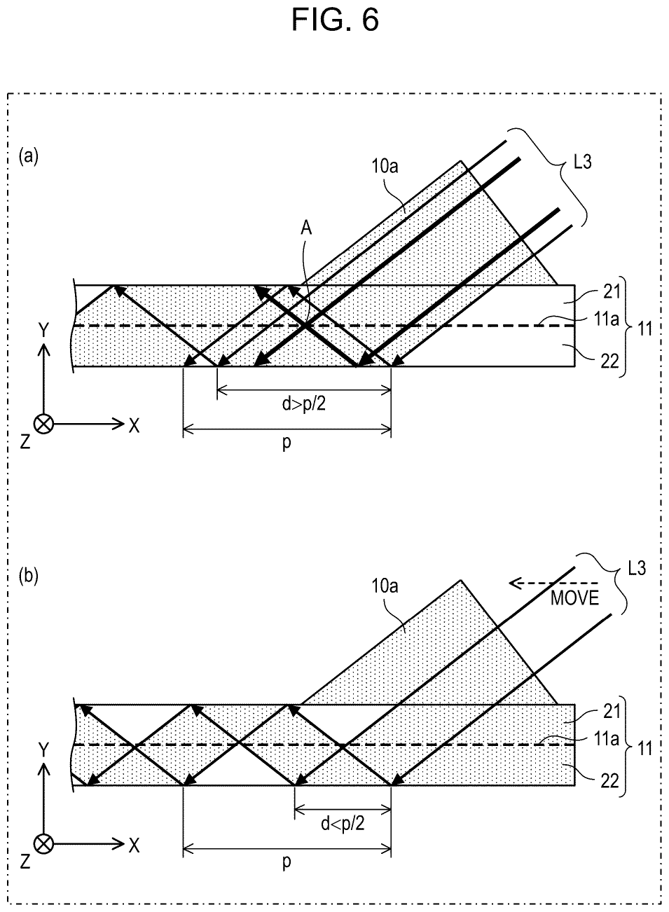

FIG. 6(a) is a cross-sectional view illustrating a state of light propagation in a volume hologram according to a comparative example, and FIG. 6(b) is a cross-sectional view illustrating a state of light propagation in the volume hologram according to the present exemplary embodiment. In FIG. 6, hologram optical element 11a is disposed in volume hologram 11 between transparent substrates 21, 22.

As illustrated in the parts (a) and (b) of FIG. 6, at a time of exposure, laser light L3 propagates in volume hologram 11 while undergoing total reflection. In the parts (a) and (b) of FIG. 6, a reflection pitch (a distance in the X direction from reflection of specific light on a lower surface of volume hologram 11 to next reflection on the lower surface of volume hologram 11) at a time of the total reflection in volume hologram 11 is denoted by p.

In FIG. 6(a), width d of laser light L3 (reference light) in the X direction is p/2 or more with respect to reflection pitch p. In this case, as illustrated in FIG. 6(a), laser light L3 propagating in light guide plate 20 overlaps in hologram optical element 11a. For example, at point A in volume hologram 11, light incident from upper left and light incident from lower left overlap each other. Therefore, these two light beams interfere with each other. As a result, interference fringes parallel in the X direction are generated in volume hologram 11 (hologram optical element 11a), and a refractive index distribution is recorded. This refractive index distribution reflects light at a reflection angle different from reflection at an air interface between transparent substrates 21, 22 in volume hologram 11 when an image signal is input to volume hologram 11. Therefore, a ghost image is generated in an image signal, thereby degrading image quality.

Therefore, as illustrated in FIG. 6(b), in the present exemplary embodiment, width d of laser light L3 (reference light) in the X direction is set to be less than p/2 with respect to reflection pitch p. As a result, light propagating through volume hologram 11 does not cause light interference on hologram optical element 11a, and generation of interference fringes parallel in the X direction in hologram optical element 11a can be prevented.

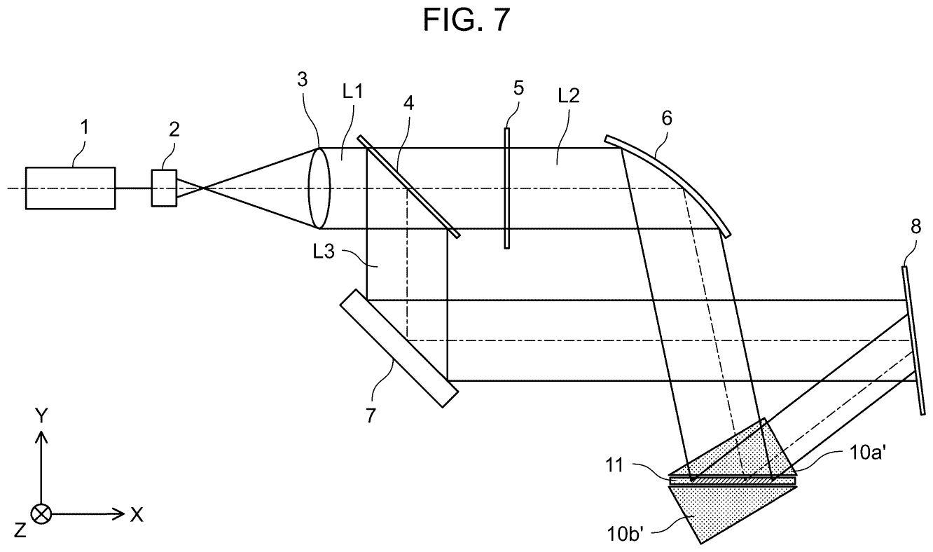

FIG. 7 is a side view of the apparatus for manufacturing a hologram optical element according to a reference example. As compared with the apparatus for manufacturing a hologram optical element according to the present exemplary embodiment, the apparatus for manufacturing a hologram optical element according to the reference example does not include slider 9, and couplers 10a′, 10b′ are each disposed in such a way as to cover entirety of one surface of volume hologram 11. In a general apparatus for manufacturing a hologram optical element, an angle of laser light L3 (reference light) with respect to the hologram light guide plate is thus adjusted by disposing each of couplers 10a′, 10b′ in such a way as to cover entirety of one surface of volume hologram 11.

On the other hand, in the present exemplary embodiment, slider 9 that moves mirror 8 in the X direction is provided. In the example of FIG. 6(b), only about half of volume hologram 11 can be formed at a time of exposure. Therefore, by moving mirror 8 using slider 9, the entire volume hologram can be exposed since a position of laser light L3 (reference light) is shifted in volume hologram 11.

For example, width d of laser light L3 in the X direction may be set to p/n, where n is an integer of 2 or more. In this case, by moving mirror 8 using slider 9, exposure is performed while moving laser light L3 in hologram optical element 11a by p/n, so that two-beam interference of laser light L2, L3 (the object light and the reference light) can be achieved.

By propagating laser light L3 (reference light) in volume hologram 11, the width of laser light L3 can be reduced, so that couplers 10a, 10b can be reduced. As a result, it is not necessary to dispose a coupler in such a way as to cover entirety of one surface of the volume hologram, so that size of the coupler can be suppressed.

With the above configuration, laser light source 1, branching mirror 4 (half mirror) that branches laser light L1 radiated from laser light source 1 into laser light L2 (first light, object light) and laser light L3 (second light, reference light), mirror 6 that reflects laser light L2, mirror 6 being created based on a shape of a product in which hologram optical element 11a is used, light guide plate 20 (volume hologram 11) including hologram optical element 11a, coupler 10a that causes laser light L3 to enter light guide plate 20 and propagate in light guide plate 20 while undergoing total reflection, and slider 9 (mover) that moves a radiation position of laser light L3 with respect to coupler 10a. As a result, in light guide plate 20 (volume hologram 11), laser light L3 can be propagated while undergoing total reflection, and hologram optical element 11a can be exposed by moving a radiation position of laser light L3 with respect to coupler 10a using slider 9. Therefore, it is not necessary to dispose a coupler in such a way as to cover entirety of one surface of the volume hologram as in the reference example. Therefore, since it is not necessary to form coupler 10a in such a way as to cover an exposure range of hologram optical element 11a, size of coupler 10a can be suppressed.

### Other Exemplary Embodiments

Note that filter 5 may be one with a fixed concentration formed with a deposited film.

Mirror 6 may also have the function of filter 5. That is, a reflection film having a predetermined concentration may be formed directly on a reflection surface of mirror 6.

In addition, although transparent substrates 21, 22 of volume hologram 11 are illustrated as flat plates in the above exemplary embodiment, transparent substrates 21, 22 may have curved surfaces, instead. In this case, it is sufficient that light does not leak from volume hologram 11 when laser light L3 is reflected from volume hologram 11. That is, transparent substrates 21, 22 may have any shapes as long as laser light L3 undergoes total reflection in volume hologram 11.

In addition, although coupler 10b is disposed on a surface of volume hologram 11 opposite a surface on which coupler 10a is provided in the above exemplary embodiment, coupler 10b may be disposed on the same surface as coupler 10a, instead.

In addition, although the movement of the radiation position of laser light L3 is achieved by the movement of mirror 8 by slider 9 in the above exemplary embodiment, the method of moving the radiation position of laser light L3 is not limited thereto. For example, another mirror may be moved by a slider or the like. Alternatively, volume hologram 11 and couplers 10a, 10b may be moved by moving means such as a slider. Alternatively, a shutter or the like that limits a radiation range of laser light L3 may be provided, and the radiation position of laser light L3 may be moved by opening and closing the shutter. In this case, laser light L3 is set to irradiate entirety of coupler 10a.

In addition, in the above exemplary embodiment, coupler 10a may be formed in such a way as to have approximately a width of laser light L3 (reference beam). In this case, coupler 10a may be moved with respect to volume hologram 11 using a slider or the like.

In addition, in the above exemplary embodiment, couplers 10a, 10b may have approximately the same size, coupler 10a may be larger than coupler 10b, or coupler 10b may be larger than coupler 10a. In addition, coupler 10b may be disposed on the same surface as coupler 10a.

In addition, in the above exemplary embodiment, mirror 6 may be formed based on a shape of a product in which volume hologram 11 is used. That is, mirror 6 may be created in consideration of the shape of the product in which volume hologram 11 is used. For example, mirror 6 may have a shape similar to the shape of the product in which volume hologram 11 is used. In this case, by adjusting a position of volume hologram 11, volume hologram 11 can be exposed according to the shape of the product in which volume hologram 11 is used. In addition, for example, mirror 6 may be created in consideration of manufacturing variations of the product in which volume hologram 11 is used. In this case, mirror 6 is designed with a median value of the manufacturing variations of the product in which volume hologram 11 is used. In addition, for example, mirror 6 may be created in accordance with a shape of a projection surface in a product using volume hologram 11 onto which light guide plate 20 projects light. In addition, for example, mirror 6 may be created in accordance with a shape of a projection surface in a product using volume hologram 11 onto which light guide plate 20 projects light. Note that although mirror 6 is formed in such a way as to have a curved surface or the like in FIG. 1 and the like, the shape of mirror 6 is not limited thereto, and may be formed in such a way as to have only a flat surface, instead.

### INDUSTRIAL APPLICABILITY

The apparatus for manufacturing a hologram optical element in the present disclosure can be applied to a hologram optical element system such as a projector, a bed-mounted display, or a head-up display.

### REFERENCE MARKS IN THE DRAWINGS

1: laser light source
5: filter
8: mirror
9: slider (mover)
10a, 10b: coupler
11: volume hologram
11a: hologram optical element
20: light guide plate
21, 22: transparent substrate

1. A hologram manufacturing apparatus comprising:
a laser light source;
a half mirror that branches light radiated from the laser light source into first light and second light;
a mirror that reflects the first light, the mirror being created based on a shape of a product in which a hologram optical element is used;
a light guide plate including the hologram optical element;
a coupler that causes the second light to enter the light guide plate and propagate in the light guide plate while undergoing total reflection; and
a mover that moves a radiation position of the second light with respect to the coupler.

2. The hologram manufacturing apparatus according to claim 1, further comprising a filter that gives an illuminance distribution to be recorded in the hologram optical element with respect to the first light.

3. The hologram manufacturing apparatus according to claim 1, wherein the mover includes a slider that moves a mirror provided for reflecting the second light and causing the second light to enter the coupler.

4. The hologram manufacturing apparatus according to claim 1, wherein the mover includes moving means for moving the volume hologram.

5. The hologram manufacturing apparatus according to claim 1, wherein when a reflection pitch of the second light in the light guide plate is denoted by p, a width of the second light in the light guide plate is less than or equal to p/2.

6. The hologram manufacturing apparatus according to claim 1, wherein when a reflection pitch of the second light in the light guide plate is denoted by p and n is an integer of 2 or more, an amount of movement of the radiation position of the second light by the mover is p/n.

7. A hologram manufacturing method comprising:
branching, using a half mirror, light radiated from a laser light source into first light and second light;
reflecting the first light using a mirror created based on a shape of a product in which a hologram optical element is used;
causing, using a coupler, the second light to enter a light guide plate including the hologram optical element and propagate in the light guide plate while undergoing total reflection; and
moving, using a mover, a radiation position of the second light with respect to the coupler.
